(19) United States
(12) Patent Application Publication
(10) Pub. No.: US 2006/0005232 A1
(43) Pub. Date: Jan. 5, 2006

(54) Path utilization device discovery

(76) Inventor: Richard A. Wilson JR., Fallbrook, CA (US)

Correspondence Address: Canon U.S.A. Inc., Intellectual Property;Department, 15975 Alton Parkway, Irvine, CA, 92618, US

(21) Appl. No.: 10/881,240

(22) Filed: Jun. 30, 2004

(51) Int. Cl. G06F 15/16; G06F 12/00; G06F 17/30; G06F 12/14; G06F 7/04; G06F 13/00; G06F 7/58; G06K 19/00; G06K 9/00; H04L 9/32; G11C 7/00

(52) U.S. Cl. 726/4; 726/16

(57) ABSTRACT

A method and system for discovering devices on a network comprising obtaining route path data and real-time path usage data from at least one routing device on the network. Devices on the network are discovered based on the combination of the obtained route path data and real-time path usage data.

### BACKGROUND OF THE INVENTION

1. Field Of The Invention

A method for discovering devices on a network. More particularly, a method for discovering devices using network routing information to discover the devices.

2. Description Of The Related Art

In today's world of computer networks, it is necessary for the administrator's of these networks to keep track of and have an updated list of the devices located on a particular network. Knowing what devices on the network is needed for such tasks as device maintenance. The current state-of-the art in network device discovery utilizes various methods for determining the available list of devices that may be serviced by a particular network.

A typical network configuration includes at least one network routing device (i.e., router). One function of a network routing device is to maintain operational information about the network it services. One piece of operational information maintained by a routing device is a routing table, which is list of routes handled by the device. In a standard device discovery operation, pings are sent to the addresses of the devices listed in the routing table. A device is considered to have been “discovered” if a response to the ping is received. In yet another device discovery operation, pings are sent to all addresses of a network, and those addresses that provide responses are considered to have devices that have been “discovered”.

While “pinging” is an effective and proven method for discovering devices, depending upon the size of the network being interrogated, device discovery could take a long time. Decreasing the time it takes to perform a device discovery operation would reduce the time the person performing the discovery operation, i.e., a network administrator spends on device discovery and allow them to concentrate on other tasks. What is needed is a method for performing device discovery on a network that is as effective as “pinging”, but performs the discovery in a much faster and more efficient manner.

### SUMMARY OF THE INVENTION

The present invention addresses the foregoing problem by providing a method of network device discovery that is effective and efficient by using route path and real-time path usage data to determine the existence of a network device.

Thus, the present invention is a method for performing a device discovery comprising the steps of obtaining route path data, obtaining real-time route usage data, and then using a combination of the route path data and the real-time route usage data to determine the existence of a device on a network.

This brief summary has been provided so that the nature of the present invention may be understood quickly. A more complete understanding of the invention can be obtained by reference to the following detailed description of the preferred embodiment(s) thereof in connection with the attached drawings.

### BRIEF DESCRIPTION OF THE DRAWINGS

FIG. 1 is a representational view depicting a general network configuration upon which discovery is performed via the present invention.

FIG. 2 is a block diagram illustrating the internal architecture of a computer utilizing the device discovery process of the present invention.

FIGS. 3A, 3B, and 3C are flowcharts describing the preferred embodiment for discovering a network device according to the present invention.

FIG. 4 is a flowchart depicting the steps for performing device discovery according to the present invention.

FIG. 5 depicts a user interface of the present invention.

FIG. 6 depicts a user interface of the present invention.

FIG. 7 depicts a user interface of the present invention.

FIG. 8 depicts a user interface of the present invention.

### DETAILED DESCRIPTION OF THE PREFERRED EMBODIMENTS

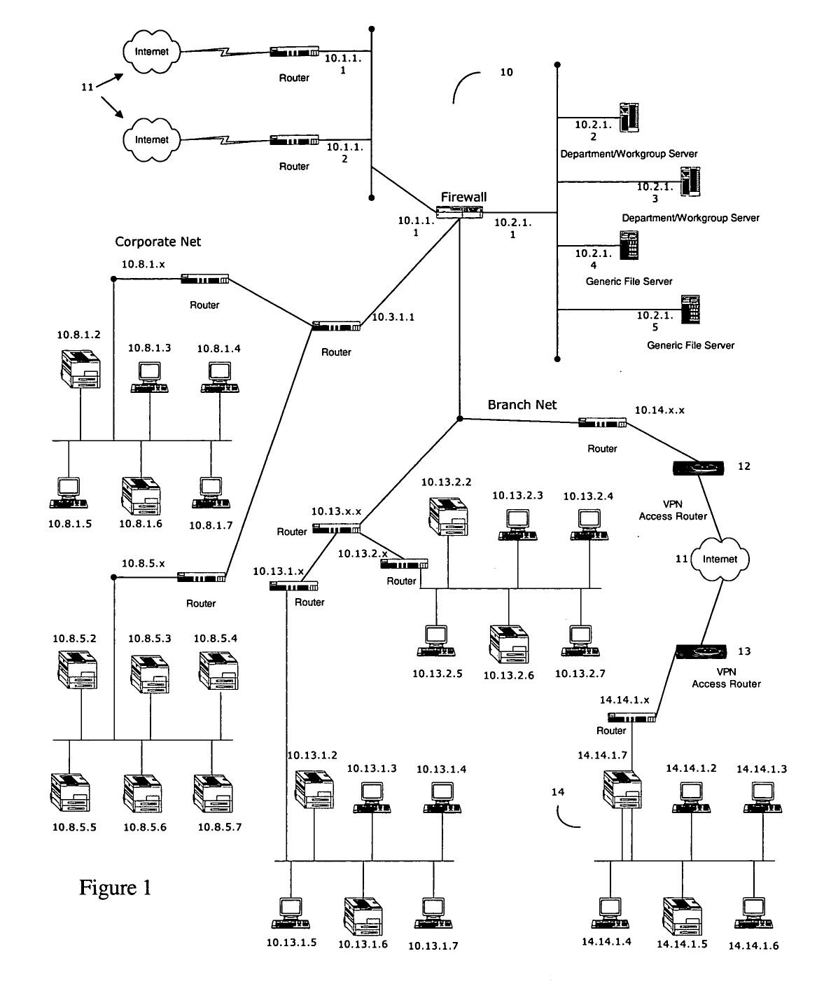

FIG. 1 is representational view depicting a general network configuration upon which discovery is performed via the present invention. Network 10 includes firewall 10.2.1.1, which separates network 10 from the Internet 11. Behind firewall 10.2.1.1 are routers 10.3.1.1, 10.8. 1.x, 10.14.x.x, 10.13.x.x, 10.13.1.x, 10.13.2.x, 10.8.5.x. Connected to each of these routers are various devices, such as printers and computer workstations. In addition, servers 10.2.1.2, 10.2.1.3, 10.2.1.4, and 10.2.1.5 are also located behind firewall 10.2.1.

Network 10 connects directly to the Internet 11 through firewall 10.2.1.1 and then via routers 10.1.1.1. and 10.1.1.2. In addition, network 10 securely connects to external network 14 via the Internet 11 using Virtual Private Network routers 12.

For illustration purposes, only one branch of network 10 will be used to describe the present invention's method of device discovery, specifically the branch associated with router 10.13.x.x. Router 10.13.x.x is responsible for routing network packets targeted for devices 10.13.1.2 through 10.13.1.7 and 10.13.2.2 through 10.13.2.7, where the packets intended for 10.13.1.2 through 10.13.1.7 are routed via router 10.13.1.x and the packets intended for 10.13.2.2 through 10.13.2.7 are routed via router 10.13.2.x.

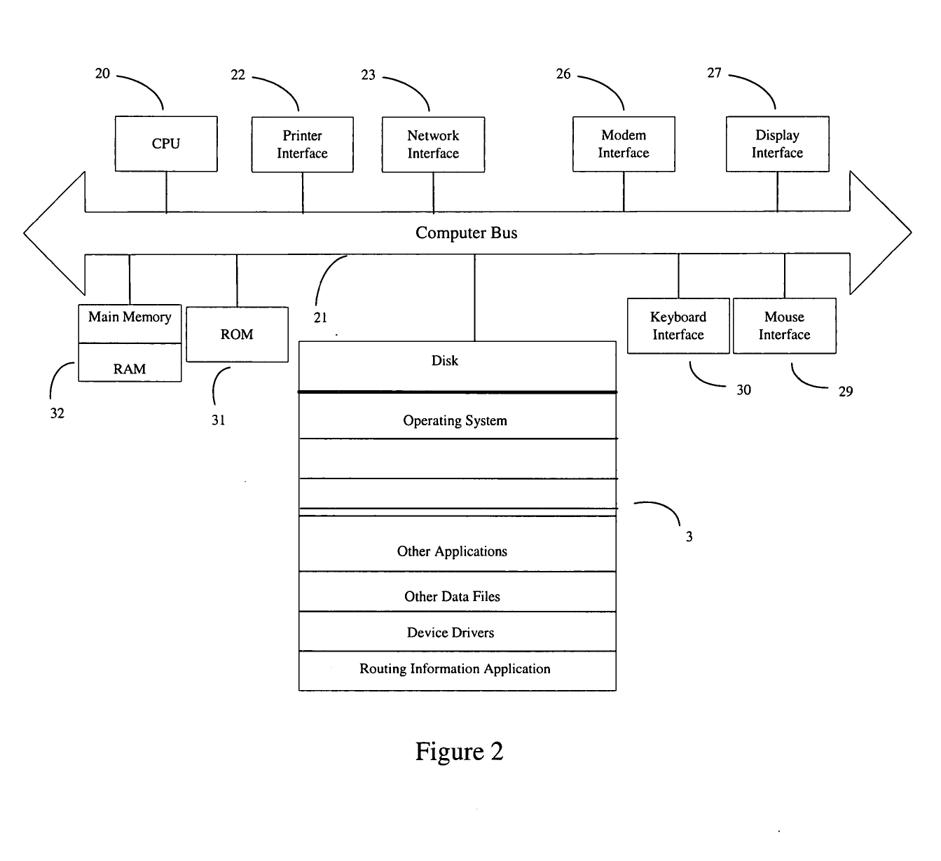

FIG. 2 is a block diagram of the internal architecture of a computer utilizing the device discovery process of the present invention. For example, the discovery process can be initiated via server 10.2.1.2. Shown in FIG. 2 is CPU 20, which can be any type of microprocessor, which interfaces to computer bus 21. Also interfacing with computer bus 21 are printer interface 22, allowing server 10.2.1.2 to communicate with a local printer (not shown), network interface 23 enabling communication between server 10.2.1.2 and network 10, modem interface 26 to enabling communication between server 10.2.1.2 and its internal modem (not shown), display interface 27 for interfacing with a display monitor (not shown), keyboard interface 30 for interfacing with a keyboard (not shown), and mouse interface 29 for interfacing with a mouse (not shown). If server 10.2.1.2 connects to Internet 11 by a means other than via network 10 or an internal modem, suitable interfaces other than network interface 23 and modem interface 26 may be utilized.

Read only memory (ROM) 31 stores invariant computer-executable process steps for basic system functions such as basic I/O, start-up, or reception of keystrokes from a keyboard. Main random access memory (RAM) 32 provides CPU 20 with memory storage that can be accessed quickly.

Also shown in FIG. 2 is disk 3, which includes an operating system, web browser, which is executable on a particular operating system, and other applications which may include word processing, spreadsheet, and graphics. Disk 3 further includes data files and device drivers as shown. In addition, disk 3 also includes the routing information application of the present invention.

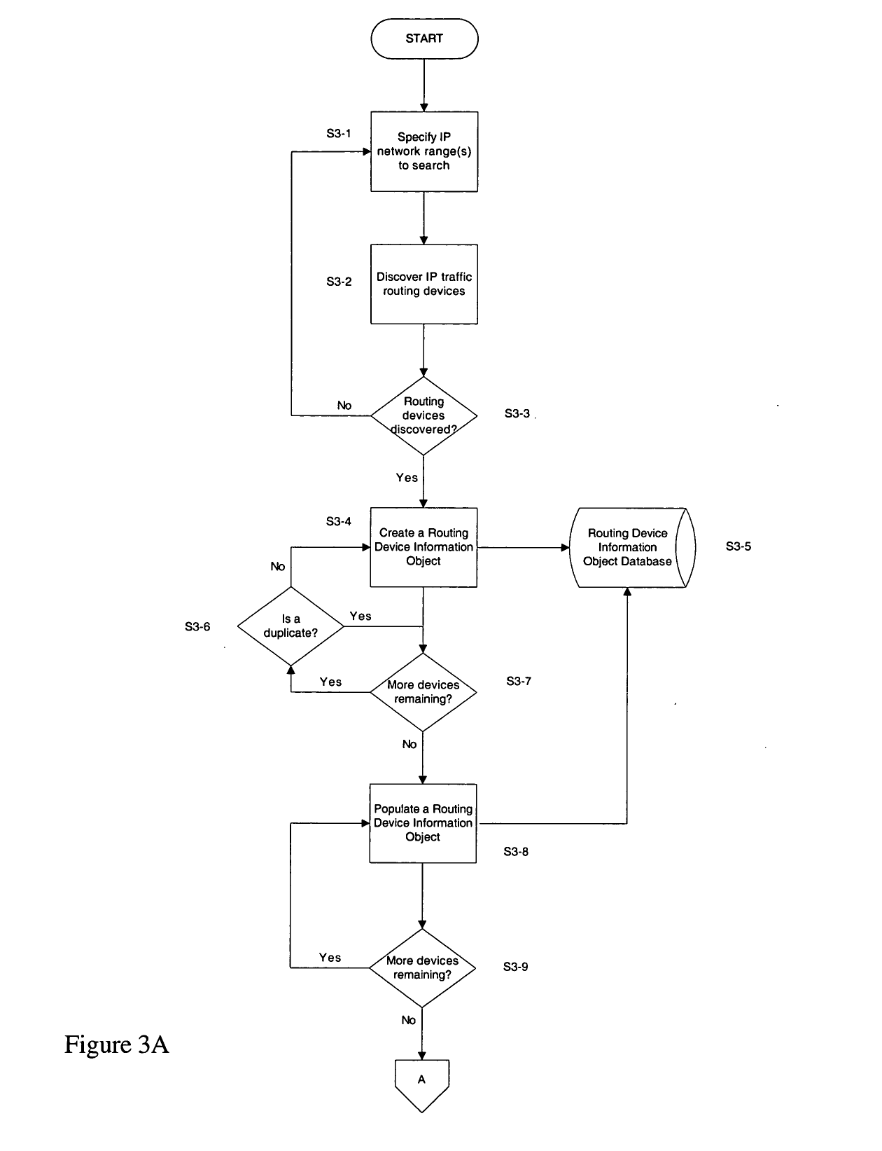

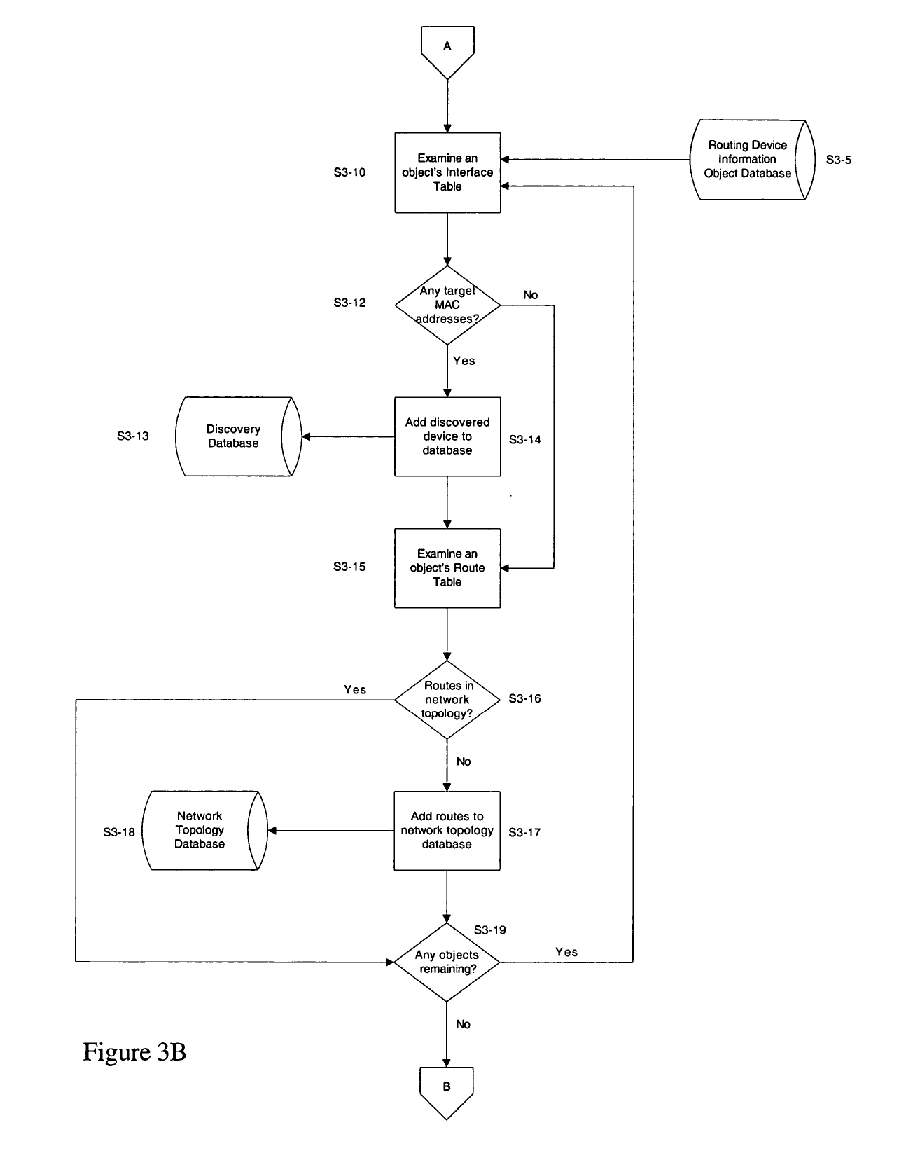

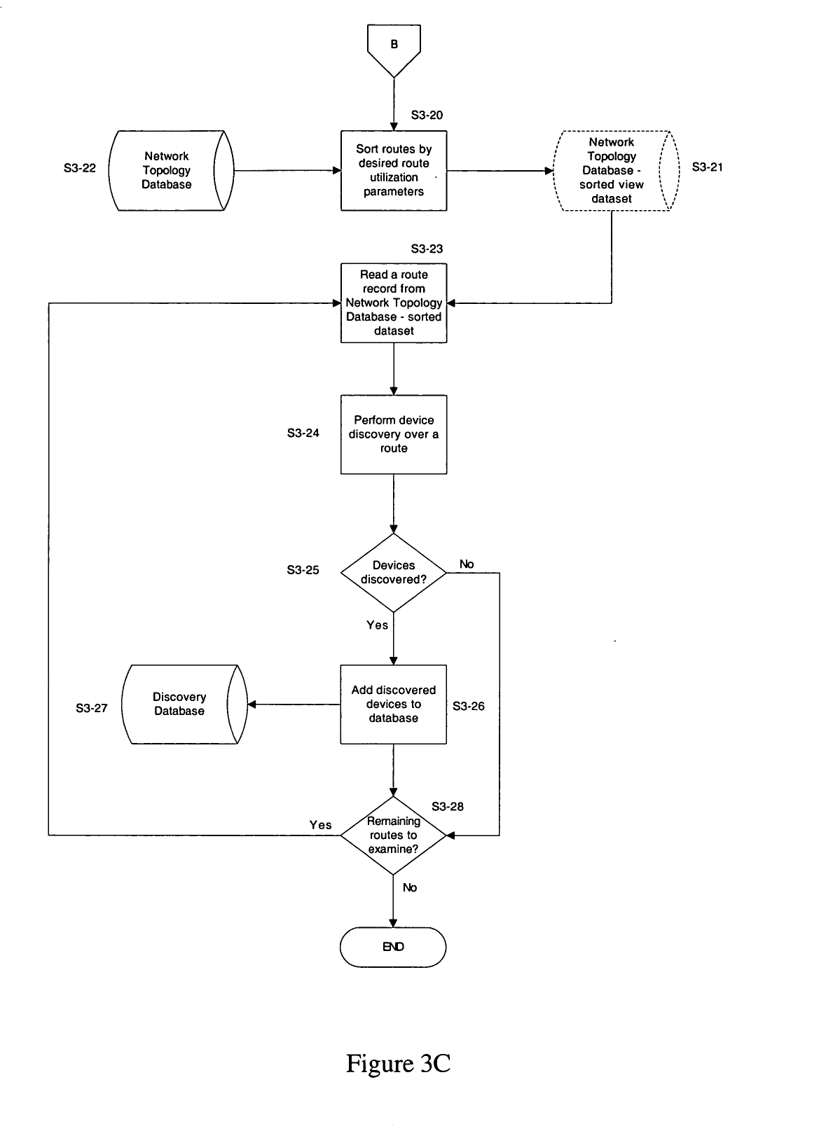

FIGS. 3A, 3B, and 3C are flowcharts describing the preferred embodiment for discovering a network device according to the present invention. Briefly, topology information such as route path data and real-time route path usage data for a particular network is obtained and a target search for network devices based on this information is performed.

In more detail, in step S3-1, a target range of IP addresses on network 10 are specified. For example, the IP addresses associated with devices 10.13.2.2 through 10.13.2.7. In addition to a target range, a list of directed or limited broadcast addresses can also be specified. Next, in step S3-2, a determination is made whether the device at a particular IP address routes IP traffic, i.e., is a routing device such as router 10.13.1.x. In order to make this determination, the SNMP RFC1213-MIB object “ipForwarding” of the device is queried for its value. A value of “1” indicates that the device forwards IP data grams, i.e., routes IP traffic. For example, router 10.13.x.x, 10.13.1.x and 10.13.2.x would each have a value of 1 in their respective “ipForwarding” objects since each of them route IP traffic to subsequent addresses from their own address.

In step S3-3, a check is performed whether any of the devices queried in step S3-2 have an “ipForwarding” value of 1. If there are any routing devices, flow proceeds to step S3-4, where a Routing Device Information Object is created. A Routing Device Information Object is a container for information retrieved from a specific routing device. After creation of the Objects in step S3-4, they are stored in the Routing Device Information Object Database in step S3-5.

Next, in step S3-7, if there are any devices determined to be routing devices that do not have a corresponding Routing Device Information Object, flow proceeds to step S3-6. In step S3-6, a check is made whether the device(s) still requiring a Routing Device Information Object is a duplicate of a device for which a Routing Device Information Object has already been created. If the results of the check in step S3-6 indicate a duplicate device, flow returns to step S3-7. If the results of the check in step S3-6 do not indicate a duplicate device, flow returns to step S3-4.

Once a Routing Device Information Object has been created and stored for all devices determined to be routing devices, the process continues to step S3-8. In step S3-8, the Routing Device Information Objects created in step S3-4 and stored in step S3-5 are populated. More specifically, the routing device in question is interrogated for all of its pertinent information, such as routing table, interface table, throughput information, and operational status. This information is then stored in the routing device's associated Routing Device Information Object in the Routing Information Object Database. This process is repeated (step 3-9) until all the routing device's have their pertinent information stored in their respective Routing Device Information object.

In step S3-10, a Routing Device Information object is retrieved from the Routing Device Information Database (step S3-5) and examined. Specifically, the “interface table” information is examined. The “interface table” contains the device(s) to which the particular routing device has forwarded/routed IP packets.

Upon examination of the “interface table”, in step S3-12, a check is made whether or not any target MAC addresses exist in the table. A quick examination for known target MAC addresses can provide initial device discovery without the need for additional network traffic/queries. If any targeted MAC addresses are found, then in step S3-14, the device is added to the Discovery Database (S3-13), which is a compilation of devices of interest to the system based on target MAC addresses or other defined criteria. Flow then proceeds to step S3-15. If no targeted MAC addresses are found in step S3-12, flow proceeds directly to step S3-15.

The routing table information of the Routing Device Information object retrieved in step S3-10 is examined in step S3-15. In step S3-16, a determination is made whether any of the routes contained in the routing table are part of the currently defined topology for network 10. In the case where the routes in the routing table are part of the currently defined network topology, flow proceeds to step S3-19. In the case where any routes contained in the routing table are not part of the currently defined network topology, flow proceeds to step S3-17.

In step S3-17, the routes that are not currently part of the current network topology are added to the network topology database (S3-18). The network topology database contains all the network routes associated with the network, as well as the route usage information (i.e., time last used, traffic utilization, etc.) for each of the routes. After updating the network topology database, flow proceeds to step S3-19. In step S3-19, a check is made whether any objects in the Route Device Information Object Database have yet to undergo the above described process. If there are still some objects remaining, flow returns to step S3-10 and steps S3-10 through S3-18 are repeated as necessary. Otherwise, flow proceeds to step S3-20.

After the network topology database has been updated, in step S3-20, the routes contained in the network topology database are extracted (S3-22) and sorted via desired route utilization parameters. For example, routes are sorted via the last time a particular route was used or the type of traffic utilizing a particular route. After the routes are sorted in step S3-20, a sorted view dataset of the network topology database is created in step S3-21.

Next, in step S3-23, a route is read from the network topology database sorted view dataset. Then in step S3-24, device discovery over that route is performed via a standard device discovery procedure, i.e. “pinging” based on the results of the sort performed in step S3-23. If in step S3-25, no devices are discovered, flow proceeds to step S3-28. If in step S3-25, any devices are discovered, flow proceeds to step S3-26. In step S3-26, the discovered devices are added to the discovery database, and then flow proceeds to step S3-28. A check is performed in step S3-28 to determine if there are any remaining routes that need to be examined for the existence of devices. If there are still routes requiring examination, the process returns to step S3-23 and steps S3-23 through S3-28 are repeated as necessary. If all of the routes have been examined, the process ends.

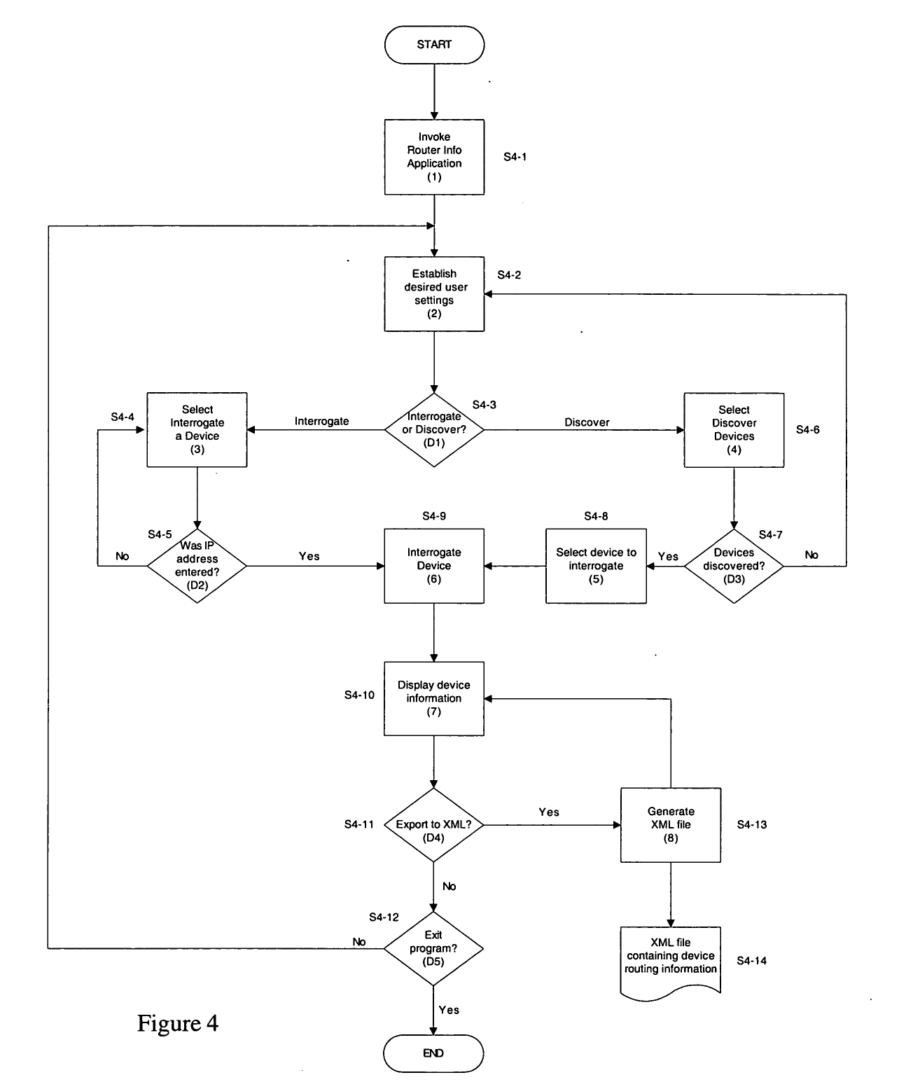

FIG. 4 is a flowchart depicting the steps for performing device discovery according to the present invention. Briefly, a user initiates a device discovery operation and then interrogates one or more of the discovered devices to obtain information about that device.

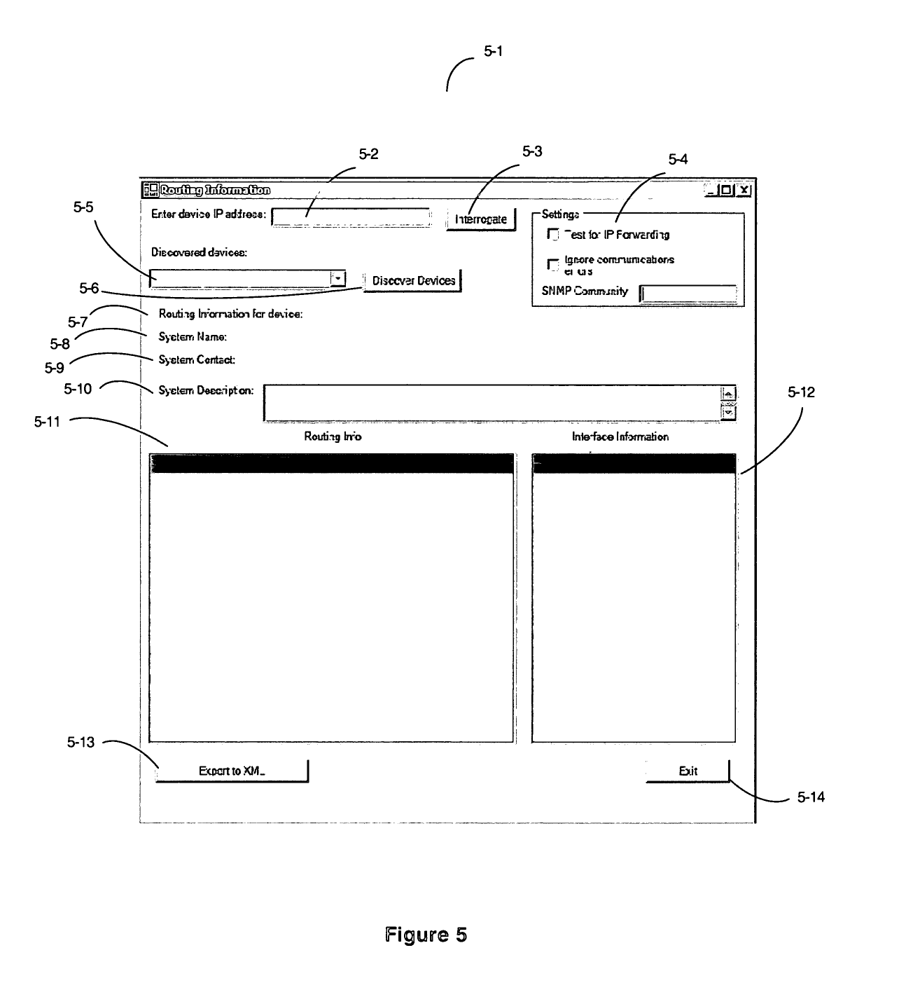

In more detail, in step S4-1, a user invokes the router information application of the present invention. Upon invoking the application, the user is presented with user interface 5-1 depicted in FIG. 5.

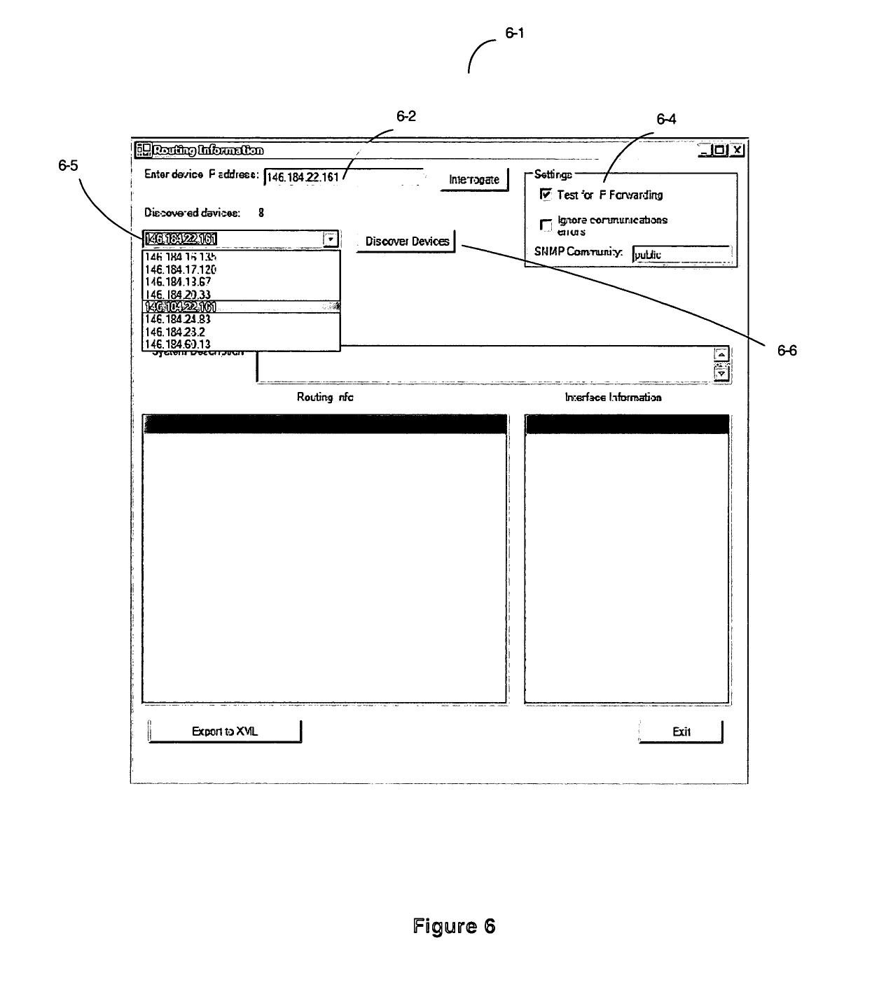

User interface 5-1 includes “Enter device IP address” field 5-2 and “Interrogate” button 5-3. Settings 5-4 section includes “Test for IP Forwarding” field, “Ignore communications errors” field, and “SNMP Community” field. “Discovered devices” field 5-5 is a drop-down list that contains a list of all the discovered devices, and its default state is blank until a device discovery operation occurs and devices are discovered. “Discover Devices” button 5-6 launches the device discovery process. “Routing Information for device” field 5-7, “System Name” field 5-8, “System Contact” field 5-9, “System Description” field 5-10, “Routing Info” field 5-11, and “Interface Information” field 5-12 provide information related to an interrogated device. User interface 5-1 also includes “Export to XML” button 5-11 and “Exit” button 5-14. All of these fields will be described in more detail below with respect to the descriptions of FIGS. 6, 7, and 8.

Returning to the flow of FIG. 4, in step S4-2, the user can set various options/settings that affect the operation of the router information application. For example, if a user knows the exact IP address of a device the user wishes to query, the user can manually enter the IP address of that device without having to perform a device discovery operation. FIG. 6 depicts an example of an IP address being entered manually. More specifically, the IP address can be entered directly into “Enter device IP address” field 6-2 of user interface 6-1. Another option would be for the user to select the desired IP address from the drop-down list of “Discovered devices” field 6-5 of user interface 6-1. This list would typically be empty unless a previous device discovery operation had occurred. Upon selection of an IP address from “Discovered devices” field 6-5, the same IP address will appear in “Enter device IP address” field 6-2.

In addition to selecting a particular IP address to query, the user can also set whether device discovery should be performed just for devices that forward IP packets (i.e. routers) via “Test for IP Forwarding” field of Settings section 6-4. By checking “Test for IP Forwarding” field, selection of “Discover Devices” field 6-6 only those devices considered to be routers will be discovered. As described above with respect to step 3-2 of FIG. 3A, “Discovered devices” field 6-5 is only populated with those devices whose SNMP RFC1213-MIB object “ipForwarding” value is 1. If “Test for IP Forwarding” field is not checked, then all devices will be discovered.

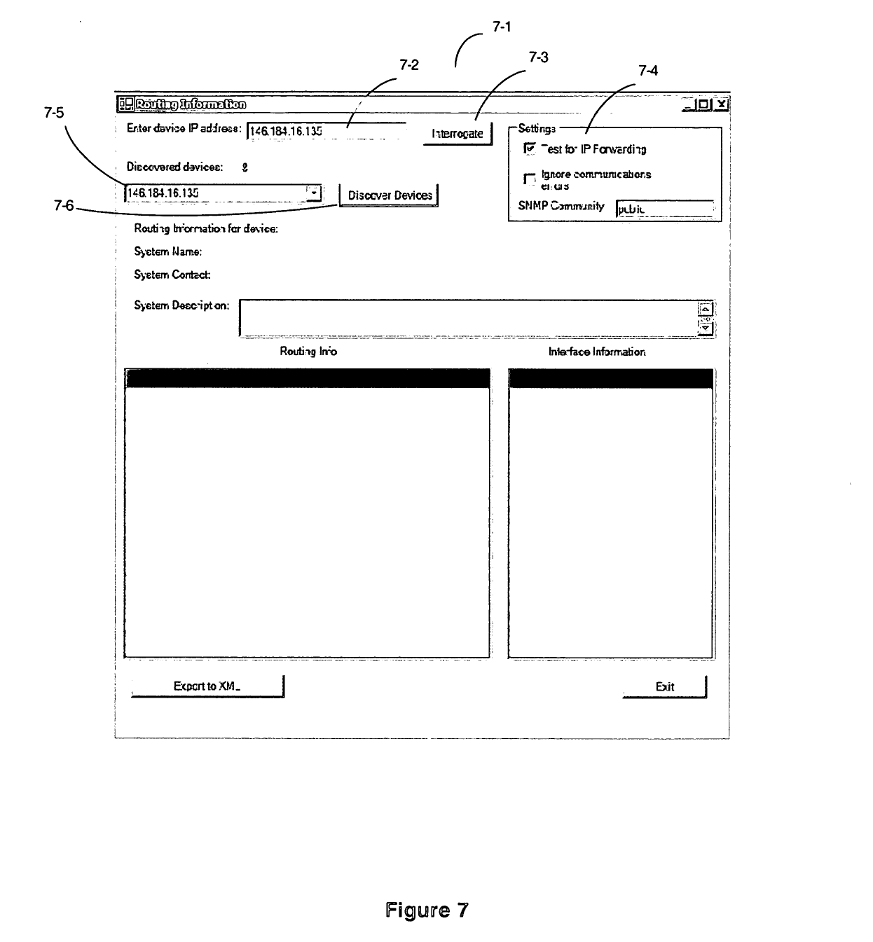

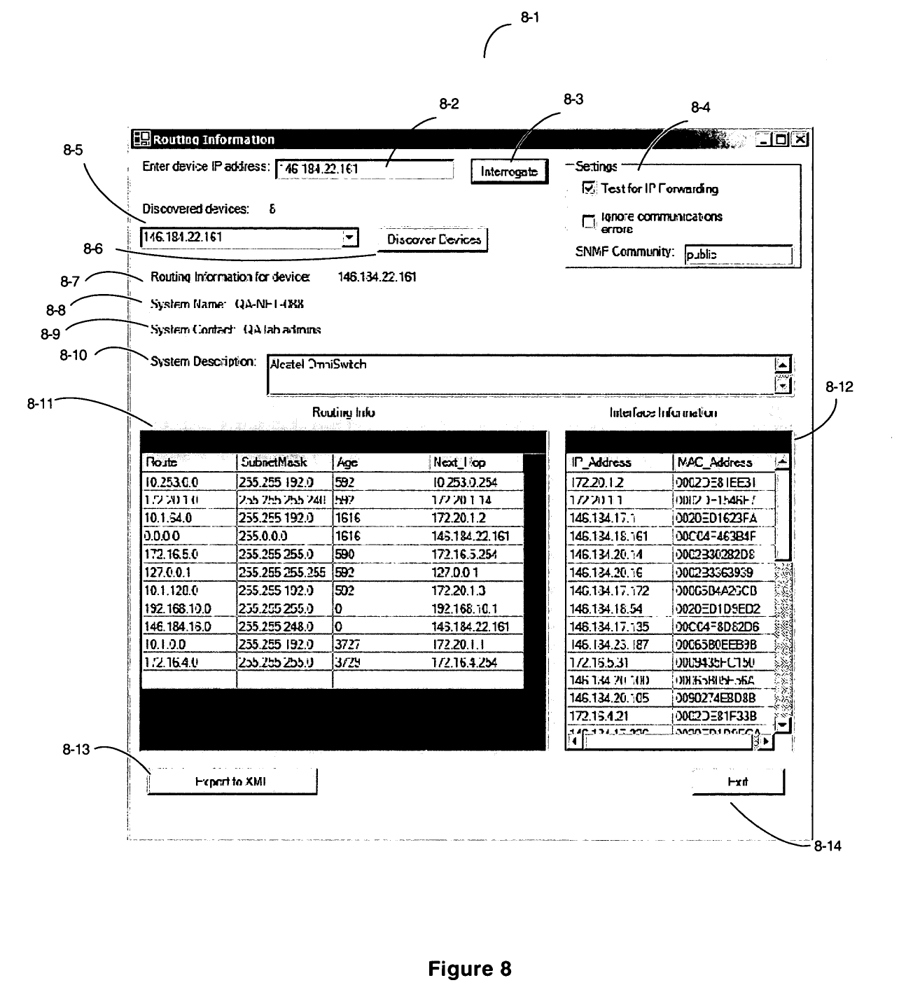

If the user checks the “Ignore Communication errors” option of Settings section 6-4, then the application will continue to query a selected device, despite any communication errors that may be encountered during querying. Communication errors may result in only partial data being collected. The process of querying a selected device is described in more detail below with respect to FIGS. 7 and 8.

Finally, the user, in the “SNMP Community” option of Settings section 6-4 can indicate the desired SNMP community name to use. Setting this option may restrict access to certain data elements within the device.

Once the user has established the desired options/settings in step S4-2, flow proceeds to step S4-3, where the user selects whether to interrogate a particular device or to perform a device discovery operation. If the user decides to interrogate a device, then in step S4-4, the user selects a particular device to interrogate. As described above, a device can be selected by either directly entering its IP address into “Enter device IP address” field 6-2 or by selecting the appropriate IP address from the drop-down list of “Discovered devices” field 6-5. User interface 7-1 of FIG. 7 illustrates the result of selecting an IP address from “Discovered devices” field 6-5. As shown in FIG. 7, the IP address in “Enter device IP address field 7-2 is the same as the IP address selected in “Discovered devices” field 7-5.

Returning FIG. 4, following selection of a device in step S4-4, a check is performed in step S4-5 to ensure “Enter device IP address” field 7-2 contains an IP address. If no IP address is present, the process returns to step S4-4, where “Enter device IP address” field 7-2 needs to be populated per one of the methods previously described. If an IP address is present, then in step S4-9, the device corresponding to the IP address is queried for information by selecting “Interrogate” button 7-3. The results of the interrogation are described below with respect to FIG. 8. If “Ignore communications errors” field in Settings section 7-4 is selected, then as described above, querying of the device will continue despite any communication errors that may occur during this process, and only partial information may be obtained.

Returning to step S4-3 of FIG. 4, if the user chooses to perform device discovery, then in step S4-6, device discovery is initiated. Device discovery commences by selection of “Discover Devices” button 5-6 from user interface 5-1, button 6-6 from user interface 6-1, button 7-6 from user interface 7-1, or 8-6 from user interface 8-1, and is performed as described in step 3-24 of FIG. 3C above.

In step S4-7, a check is performed to determine if any devices were discovered. If no devices were discovered, or the user determines too few devices were discovered, the process returns to step S4-2, where the user can adjust the options/settings to increase the discovery results. If devices were discovered and the user is satisfied with the results of the discovery, then flow proceeds to step S4-8.

In step S4-8, the user selects a particular device to interrogate from a list of discovered device, i.e., “Discovered devices” field 6-5 of user interface 6-1 or enters the device to interrogate via “Enter device IP address” field 6-2. Following selection of the device, in the selected device is queried for information in step S4-9 as described above.

Upon retrieval of information from the selected device in step S4-9, the information is then displayed in various fields and tables in step S4-10. User interface 8-1 of FIG. 8 depicts the results of a device interrogation operation initiated by selecting “Interrogate” button 7-3. The IP address shown in “Enter device IP address” field 8-2 and “Discovered devices” field 8-5 are the same, indicating that the IP address was selected via the drop-down list of “Discovered devices” field 8-5. As a result of interrogating the device associated with the IP address, “Routing Information for device” field 8-7 is populated with the IP address, “System Name” field 8-8 is populated with the name of the device at that IP address, “System Contact” field 8-8 is populated with name of the person responsible for the device, and “System Description” field 8-10 contains a description of the device.

In addition, “Routing Info” field 8-11 is also populated when “Interrogate” button 7-3 is selected. “Routing Info” field 8-11 contains a list of all the routes in network 10 associated with the device at the IP address listed in “Enter device IP address” field 8-2. “Interface Information” field 8-9 is populated with a list of all the devices the device at the IP address listed in “Enter device IP address” field 8-2 has “seen”, i.e., it has contacted or routed network packets to those devices, when “Interrogate” button 7-3 is selected.

Next, in step S4-11, the user is provided an option to export the retrieved information via a standard XML file. If the user chooses to export the information, then in step S4-13, “Export to XML” button 8-10 of user interface 8-1 would be selected and the retrieved information formatted into standard XML and output to a user selected storage location. Flow then returns to step S4-10, where user interface 8-1 is again displayed.

If in step S4-11 the user does not choose to export the retrieved information, then in step S4-12, the user may elect to end the router information application. Selection of “Exit” button 8-11 closes the application. If the user wishes to proceed using the application, the process returns to step S4-2.

While the invention is described above with respect to what is currently its preferred embodiment, it is to be understood that the invention is not limited to that described above. To the contrary, the invention is intended to cover various modifications and equivalent arrangements within the spirit and scope of the appended claims.

What is claimed is:

1. A method for device discovery comprising:
obtaining route path data;
obtaining real-time path usage data; and
determining, based on the obtained route path data and real-time path usage data, the existence of a device.

2. A method according claim 1, wherein the device discovery occurs on a computer network.

3. A method according to claim 2, wherein the route path data is obtained from at least one routing device on the network.

4. A method according to claim 3, wherein the route path data includes a list of routes on the network handled by the routing device.

5. A method according to claim 2, wherein the real-time path usage data is obtained from at least one routing device on the network.

6. A method according to claim 5, wherein the real-time path usage data includes a measure of time since a route serviced by the routing device was last utilized.

7. A system for device discovery comprising:
obtaining means to obtain route path data;
obtaining means to obtain real-time path usage data; and
determining means to determine, based on the obtained route path data and real-time path usage data, the existence of a device.

8. A system according to claim 7, wherein the device discovery occurs on a computer network.

9. A system according to claim 8, wherein the route path data is obtained from at least one routing device on the network.

10. A system according to claim 9, wherein the route path data includes a list of routes on the network handled by the routing device.

11. A system according to claim 8, wherein the real-time path usage data is obtained from at least one routing device on the network.

12. A system according to claim 11, wherein the real-time path usage data includes a measure of time since a route serviced by the routing device was last utilized.

13. Computer-executable program code stored on a computer-readable medium, the computer-executable program code for discovering a device, the computer-executable program code comprising:
code to obtain route path data;
code to obtain real-time usage data; and
code to determine, based on the obtained route path data and real-time usage data, the existence of a device.

14. Computer-executable program code according to claim 13, wherein the device discovery occurs on a computer network.

15. Computer-executable program code according to claim 14, wherein the route path data is obtained from at least one routing device on the network.

16. Computer-executable program code according to claim 15, wherein the route path data includes a list of routes on the network handled by the routing device.

17. Computer-executable program code according to claim 14, wherein the real-time path usage data is obtained from at least one routing device on the network.

18. Computer-executable program code according to claim 17, wherein the real-time path usage data includes a measure of time since a route serviced by the routing device was last utilized.

19. A computer-readable medium which stores computer-executable process steps, the computer-executable process steps for discovering a device, the computer-executable process steps comprising:
an obtaining step to obtain route path data;
an obtaining step to obtain real-time usage data; and
a determining step to determine, based on the obtained route path data and real-time usage data, the existence of a device.

20. A computer-readable medium according to claim 19, wherein the device discovery occurs on a computer network.

21. A computer-readable medium according to claim 20, wherein the route path data is obtained from at least one routing device on the network.

22. A computer-readable medium according to claim 21, wherein the route path data includes a list of routes on the network handled by the routing device.

23. A computer-readable medium according to claim 20, wherein the real-time path usage data is obtained from at least one routing device on the network.

24. A computer-readable medium according to claim 23, wherein the real-time path usage data includes a measure of time since a route serviced by the routing device was last utilized.
